(19) United States
(12) Patent Application Publication
(10) Pub. No.: US 2010/0142463 A1
(43) Pub. Date: Jun. 10, 2010

(54) FRAME-BASED ON-DEMAND SPECTRUM CONTENTION PROTOCOL-MESSAGING METHOD

(75) Inventor: Wendong Hu, San Jose, CA (US)

Correspondence Address: STMICROELECTRONICS, INC., MAIL STATION 2346, 1310 ELECTRONICS DRIVE, CARROLLTON, TX, 75006, US

(73) Assignee: STMicroelectronics, Inc., Carrollton, TX (US)

(21) Appl. No.: 12/616,012

(22) Filed: Nov. 10, 2009

Related U.S. Application Data
(60) Provisional application No. 61/120,239, filed on Dec. 5, 2008.

(51) Int. Cl. H04W 72/04; H04L 27/28

(52) U.S. Cl. 370/329; 375/260

(57) ABSTRACT

The message flows of a distributed, cooperative, and real-time protocol for frame-based spectrum sharing called Frame-based On-Demand Spectrum Contention (FODSC) employs interactive MAC messaging on an inter-network communication channel to provide efficient, scalable, and fair inter-network spectrum sharing among the coexisting cognitive radio cells.

### CROSS REFERENCE TO PRIORITY AND RELATED PATENT APPLICATION

This application claims the benefit of U.S. Provisional Patent Application No. 61/120,239, filed on Dec. 5, 2008, which is hereby incorporated by reference for all purposes as if fully set forth herein.

The present invention is also related to the subject matter disclosed in U.S. patent application Ser. No. ______ filed on DDMMYY for: “SUPER-FRAME STRUCTURE FOR DYNAMIC SPECTRUM SHARING IN WIRELESS NETWORKS”, assigned to the assignee of the present invention, the disclosure of which is herein specifically incorporated by this reference in its entirety.

### BACKGROUND OF THE INVENTION

The present invention relates to wireless systems and, more specifically to a super-frame structure and a frame-based on-demand spectrum contention protocol-messaging method that allows efficient spectrum sharing and cross-channel inter-cell communications for IEEE 802.22 systems.

In recent years wireless systems have been proliferating. Wireless networks share a scarce resource, the electromagnetic spectrum, which results in bandwidth contention and RF interference between individual nodes and subnets, and opens the door for novel security threats. Since the wireless spectrum is a limited resource, there is significant economic pressure to use the spectrum efficiently. Spectrum sharing is difficult since wireless systems are typically not isolated by frequency from each other for wireless subnets desiring to share spectrum in the same physical area. Even though spectrum is a shared resource, it is currently not being used efficiently, both for regulatory and technical reasons. It is critical that any proposed solution for spectrum sharing must allow users to negotiate access to spectrum and must be able to switch between frequencies and protocols.

Although avoiding harmful interference to licensed incumbents is the prime concern of the system design for the emerging cognitive radio (white space radio) technologies, another key design challenge to these systems, such as IEEE 802.22 systems, is how to dynamically share the scarce spectrum among the collocated cognitive network cells so that performance degradation, due to mutual co-channel interference, is effectively mitigated.

What is desired, therefore, is a solution to allow efficient dynamic spectrum sharing in overlapping wireless systems.

### SUMMARY OF THE INVENTION

This invention describes the message flows of a distributed, cooperative, and real-time protocol for frame-based spectrum sharing called Frame-based On-Demand Spectrum Contention (FODSC) that employs interactive MAC messaging on an inter-network communication channel to provide efficient, scalable, and fair inter-network spectrum sharing among the coexisting cognitive radio cells.

### BRIEF DESCRIPTION OF THE DRAWINGS

The present invention is illustrated by way of example and not by limitation in the accompanying figures in which like reference numerals indicate similar elements and in which:

FIGS. 1(a) and 1(b) are diagrams that illustrate the basic ODSC messaging flow;

FIG. 2 is a diagram that illustrates the ODSC message flow between one source and two two-hop destinations;

FIG. 3 is a diagram that illustrates the ODSC message flow between multiple sources and multiple destinations;

FIG. 4 is a diagram of a super-frame structure according to the present invention showing sixteen frames, wherein a first frame includes a super-frame preamble, a super-frame control header, a data portion, and a regular self-coexistence window, an intermediate frame includes an OFDM symbol, a data portion, and a regular self-coexistence window, and a last frame includes an OFDM symbol, a data portion, and a joining self-coexistence window;

FIG. 5 is a diagram of three-symbol coexistence beaconing protocol data unit according to the present invention, including a preamble, header, super-frame control information, and information element;

FIG. 6 is a diagram of two super-frames being employed by two different wireless networks, showing the inter-wireless network communications for negotiating spectrum sharing, and an intra-wireless network announcement announcing the results of the negotiations;

FIG. 7 is a flow chart of the frame-based on-demand spectrum contention protocol-messaging method of the present invention;

FIG. 8 is a super-frame diagram showing an example of the protocol-messaging method of the present invention being practiced amongst five wireless networks;

FIG. 9 is a super-frame diagram showing an example of the protocol-messaging method of the present invention being practiced amongst a source and a destination wireless network; and

FIG. 10 is a super-frame diagram showing an example of the protocol-messaging method of the present invention being practiced amongst two source wireless networks and a destination wireless network.

### DETAILED DESCRIPTION

To completely understand the method of the present invention, On-Demand Spectrum Contention (“ODSC”) for fair and efficient inter-cell spectrum sharing in cognitive radio networks is explained. Next, a super-frame structure for dynamic spectrum sharing in wireless networks is explained. Finally, the frame-based on-demand spectrum contention protocol-messaging method according to the present invention is then explained.

In the emerging IEEE 802 standards (802.16h, 802.22), Cognitive Radio (CR) has been employed as an enabling technology that allows unlicensed radio transmitters to operate in the licensed bands at locations where that spectrum is temporally not in use.

In addition to avoidance of harmful interference to licensed incumbent services as the first priority, another key challenge that CR based Wireless Access Networks (CRWAN) should address is how a CRWAN cell coexists with the nearby CRWAN cells by sharing the spectrum that is unused by licensed incumbents.

To that end, a distributed, cooperative, and real-time spectrum sharing protocol called On-Demand Spectrum Contention (ODSC) is used. The basic mechanism of ODSC is simple: on an on-demand basis, base stations of the coexisting CRWAN cells contend for the shared spectrum by exchanging and comparing randomly generated spectrum access priority numbers through MAC layer messaging on an independently accessible Coexistence Management Channel as described below. The contention decisions are made by the coexisting cells in a distributed way. Only the winner CRWAN cell, which possessed a higher spectrum access priority compared to those of the other contending cells (the losers), can occupy the spectrum that is being contended for.

As opposed to the traditional contention based medium access schemes such as Aloha and CSMA, which resolve the spectrum contention by deferring packet transmission with random periods, the contention resolution in ODSC protocol is based on interactive message exchange conducted on the independent management channel, thus it does not cause any random delay on packet transmission, and moreover effectively avoids packet collisions and the hidden-node problem.

Before initiating MAC layer messaging of ODSC protocol, a CRWAN cell that is demanding for additional spectrum resource first evaluates and selects a channel that licensed incumbent is not occupied. The CRWAN base station then verifies if the selected channel can be simultaneously shared, employing the transmit power control (TPC) technique, with all other communication systems that are operating on the same channel without causing any harmful interference to one another. If simultaneous sharing of the selected channels is feasible, the CRWAN system then schedules data transmissions on the selected channels with appropriate TPC settings. On the other hand, if simultaneous sharing is not feasible (i.e. the coexisting cells are operating on the selected channel within the interference range of one another where TPC can not satisfy the performance constraints of the coexisting cells), ODSC messaging takes place allowing coordinated spectrum contention among the ODSC protocol-compliant CRWAN cells to share the target channel in a time-sharing manner.

The basic ODSC messaging procedure is explained below.

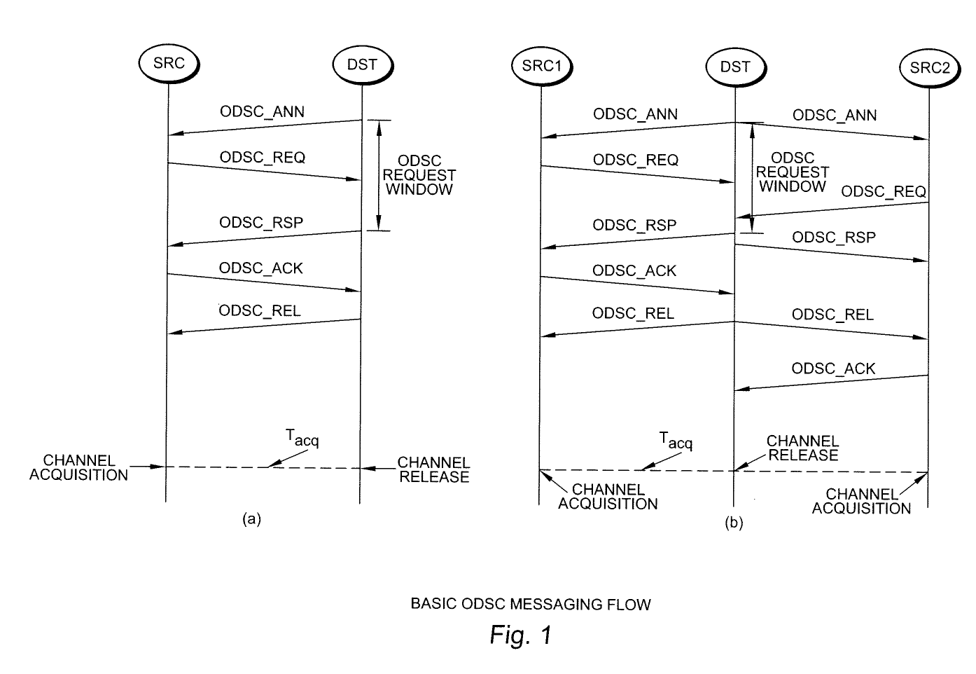

FIG. 1(a) depicts the basic MAC messaging flow of the ODSC protocol between two CRWAN cells that are within interference range of each other (i.e. the “one-hop” neighbors). The MAC messages are delivered by robustly designed coexistence beacons such that the MAC messages can be received by all coexisting cell within one-hop.

During a network discovery stage, a spectrum-demanding CRWAN cell, referred to as ODSC source (SRC) captures the ODSC announcement messages (ODSC_ANN) regularly broadcasted by a spectrum occupier CRWAN cell, referred to as ODSC destination (DST). Driven by the spectrum demand for supporting its data services, SRC sends an ODSC request message (ODSC_REQ), which includes a spectrum access priority number (SAPN), a floating point number uniformly selected between 0 and 0.999999, to the discovered DST. DST maintains an ODSC request window so as to allow multiple SRCs that submit ODSC_REQ messages at different time instances to have fair chances to participate in the contention process. FIG. 1(b) illustrates the scenario in which multiple SRCs (SRC1 and SRC2) are contending a channel with a DST. At the end of an ODSC request window, DST randomly generates its own SAPN and compares it with the smallest SAPN selected from the ones carried in the ODSC_REQ messages received from different SRCs within the request window. If the DST's SAPN is smaller (i.e. possesses higher priority), DST sends each SRC an ODSC_RSP message indicating a contention failure. Otherwise, the SRC with the smallest SAPN will receive an ODSC_RSP message with an indication of contention success (e.g. SRC1 in FIG. 1(b)), and all the other SRC will be informed a failure by the DST. Upon receipt of a success notice, the winner SRC schedules the channel acquisition at and broadcasts an ODSC acknowledgement message (ODSC_ACK) that indicates the channel acquisition time (T_{acq}) and confirm the action of channel acquisition. After the ODSC_ACK is received from the winner SRC, DST schedules a channel release operation to occur at T_{acq} (which is obtained from the ODSC_ACK) and broadcasts an ODSC_REL message, which contains the information about the channel to be release, the release time (set to be same as T_{acq}), and the ID of the winner SRC that will acquire the channel, to the neighborhood. In order to enhance the channel use efficiency, the other SRCs (including the ones just lost the contention with DST) that capture the ODSC_REL message will also schedule channel acquisition at T_{acq} as long as it is determined from the ODSC_REL that a 1-hop DST is releasing the channel to a 2-hop neighbor.

As briefly mentioned above, a typical coexistence scenario may include multiple spectrum occupiers (ODSC destinations) and requesters (ODSC sources) that could be either one-hop or multi-hop apart. Proper ODSC message exchanges are required among the coexisting cells to avoid the “hidden node” problem (two cells are out of range of each other but within the range of a central cell) and enhance spectrum reuse efficiency. The ODSC message flows for a number of basic scenarios in which multi-hop coexisting cells exist are explained below. The message flow for a more sophisticated scenario can be readily derived from these basic scenarios.

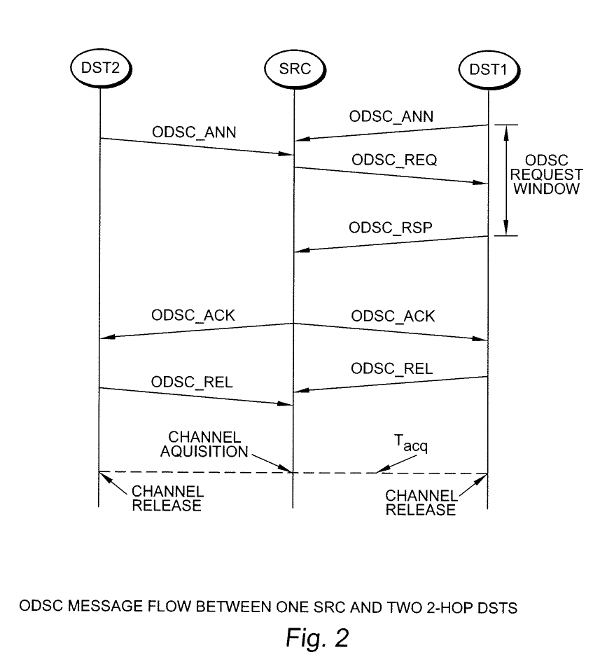

FIG. 2 shows a coexistence scenario where a SRC is within one-hop distance from multiple DSTs (DST1 and DST2) which are occupying the same channel. To contend for the channel, SRC randomly select one of the DSTs (e.g.

DST1) with which SRC will initiate the ODSC process as described above. If the channel is granted after winning the contention, SRC broadcasts an ODSC_ACK message to all DSTs. Besides DST1, the other DSTs that were not selected for the contention (e.g. DST2) will schedule channel release at T_{acq} as indicated in the ODSC_ACK after determining that a 2-hop neighbor (DST1) is to release the channel to a one-hop neighbor (SRC).

When there exists multiple DSTs and SRCs in a coexistence scenario, it is likely that different SRCs could select their own DSTs to contend for the same spectrum resource as the destination selection is fully random. Since the contention resolution processes at different DSTs or SRCs are independent, however, there may exist multiple contention decisions being simultaneously circulated through control messages among the coexisting cells. Care should be taken to manage the discrepancies between these independent decisions in order to ensure the stability of the coexistence behaviors and avoid loss of spectrum reuse efficiency across the network.

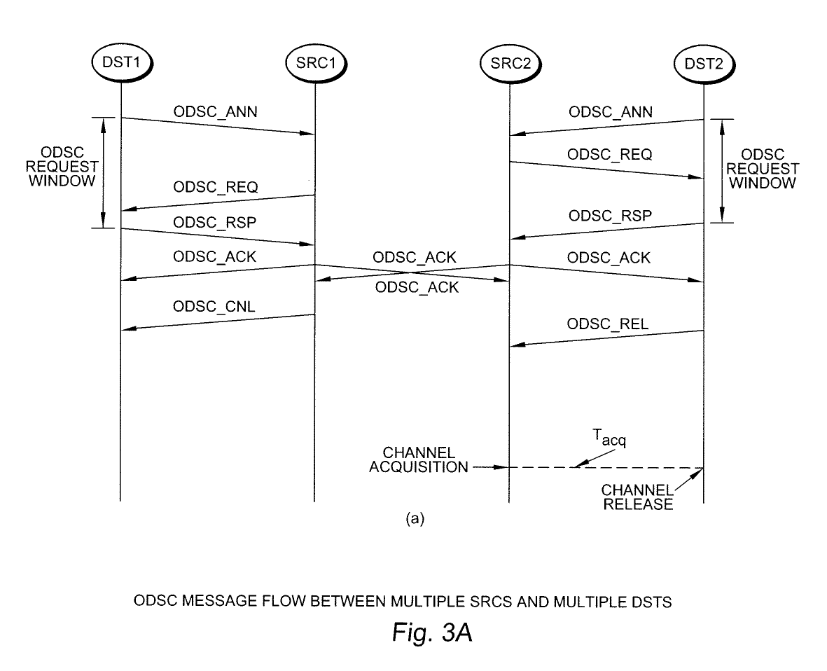

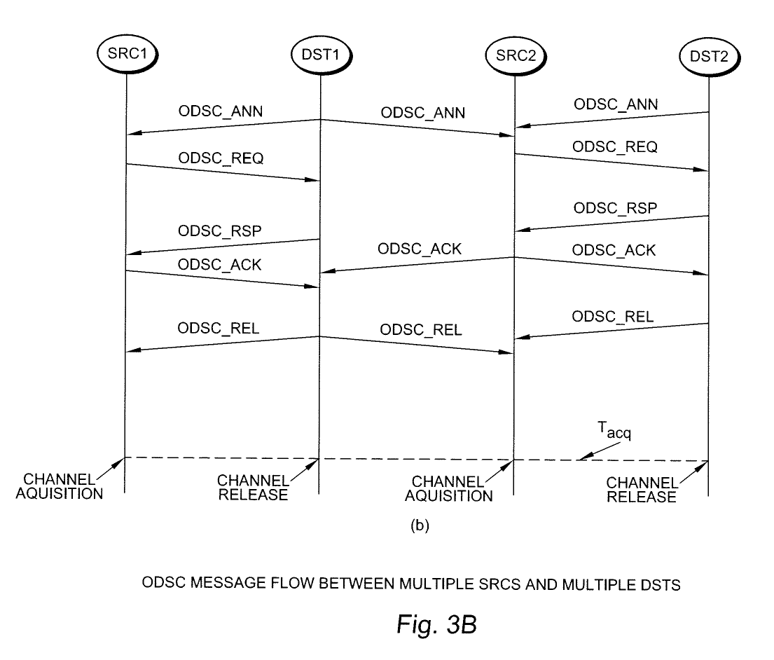

FIG. 3 shows two basic scenarios where two SRCs coexist with two DSTs sharing the same spectrum resource. In FIG. 3(a), two one-hop SRCs (SRC1 and SRC2) may simultaneously content for the same channel with DST1 and DST2 respectively, and may both be granted for channel acquisition approximately at the same time as the outcomes of the independent contentions. In order to avoid the collision between SRC1 and SRC2 in case they both switch to the channel, the time stamp indicating the time at which the contention was resolved is included in the ODSC_ACK message, which is broadcasted to all 1-hop neighbors after the channel was granted. In this way, both SRC1 and SRC2 can capture each other's ODSC_ACK message, and only the one (e.g. SRC2) that possesses the earlier time stamp will proceed with the channel acquisition. The SRC with a bigger time stamp (e.g. SRC1) will transmit to the corresponding DST an ODSC_CNL message to cancel the schedule of channel acquisition/release. FIG. 3(b) shows another basic way in which two SRCs and two DSTs may coexist. In this case, SRC1 and SRC2 may both successfully obtain the right to acquire the channel from DST1 and DST2 respectively at approximately the same time. The channel acquisition times selected by SRC1 and SRC2, however, are likely different. This discrepancy in acquisition time can cause collision in channel use, for example, between SRC2 and DST1, when the channel acquisition time selected by SRC2 is earlier than the channel release time of DST1 (which is equal to the channel acquisition time selected by SRC1). This problem can be overcome simply by using the ODSC_ACK and ODSC_REL messages that are respectively broadcasted by DSTs and SRCs to coordinate a proper timing for channel switching between the nearby cells.

ODSC is an iterative process driven by two types of spectrum-sharing demands:
1) Intra-cell demand, which is generated internally by a CRWAN cell itself as a result of increasing requirement for spectrum resources. A CRWAN cell, when triggered by its own intra-cell demand, will initiate the spectrum acquisition procedure.
2) Inter-cell demand, which indicates a spectrum contention request originated from a neighbor cell hunting for available spectrum. A CRWAN cell, being a spectrum resource occupier, upon receipt of an inter-cell demand (a spectrum contention request) will resolve the spectrum contention (determining the winner of the contention) and response to the contention request.

The spectrum contention decisions based on these spectrum sharing demands are made independently by each coexisting CRWAN cells. Through analytical and simulation modeling efforts, it has been demonstrated that ODSC, integrating transmission power control (TPC) and dynamic frequency selection (DFS) techniques with cooperative spectrum contention, provides satisfied fairness, efficiency, and scalability for dynamic spectrum access operations.

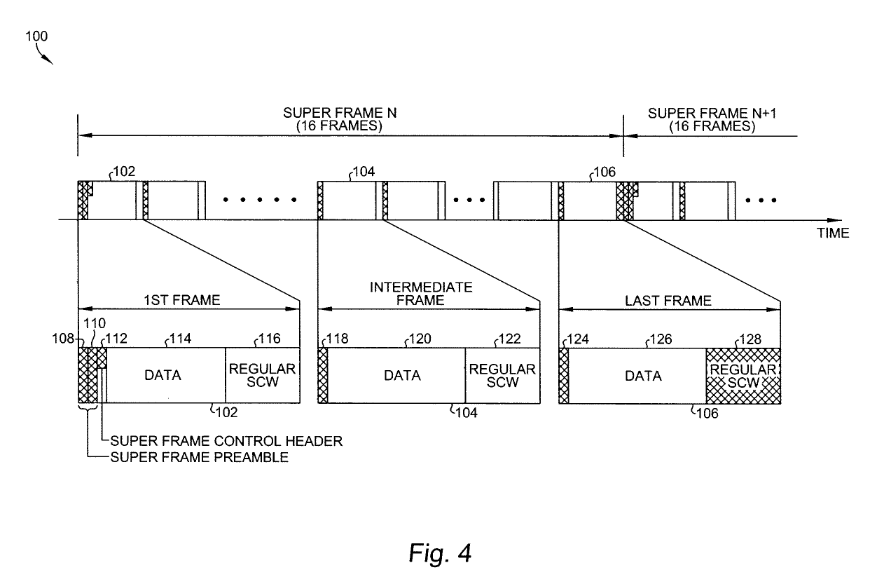

Now that the ODSC mechanism has been explained, a super-frame structure for dynamic spectrum sharing in wireless networks is now explained. Referring now to FIG. 4, a super-frame structure 100 is shown in the time domain according to an embodiment of the present invention. The purpose of the super-frame structure is to allow dynamic spectrum sharing between wireless systems that are operating in the same proximity and have overlapping coverage areas. The super-frame structure allows negotiation and coordination between wireless systems regarding the specifics of spectrum sharing, and the announcement of those negotiations so that other unlicensed systems in the coverage area can be notified.

The super-frame structure 100 of the present invention includes, for example, sixteen frames including a first frame 102, an intermediate frame 104, and a last frame 106. Although sixteen frames are shown in FIG. 1, the principle of the present invention is not obviated by using a different number of frames. The first frame includes a super-frame preamble including two OFDM symbols 108 and 110. The use of two OFDM symbols 108 and 110 is for robust identification to other wireless systems. Immediately after the super-frame preamble, there is a super-frame control header 112. The super-frame control header 112 is described in further detail below. The super-frame control header 112 may or may not need all of the available bandwidth during its allotted time slot. Immediately after the super-frame control header 112, there is the data payload 114, which is the information that is being transmitted among wireless systems in the coverage area of a wireless network. Finally, after the data payload 114, there is a “regular” self-coexistence window 116, which is also described in further detail below. The regular self-coexistence window 116 can be reserved by a particular wireless network. A representative intermediate frame 104 includes a preamble that occupies an OFDM symbol 118. Following the symbol 118 is the data payload 120. Finally, a regular self-coexistence window 122 is shown, which can also be reserved by a wireless system wishing to communicate with other wireless systems. The remaining intermediate frames are not shown in FIG. 1, but their structure would be the same as the intermediate frame 104 that is shown in FIG. 1. A last frame 106 includes a preamble 124, a data payload 126, and a “joining” self-coexistence window 128. The joining self-coexistence window 128 is different from the other self-coexistence windows in that it cannot be reserved. Any wireless system may occupy this self-coexistence window using a contention-based method, as is explained below. Joining self-coexistence window 128 is used so that new-corner wireless systems may join in the spectrum sharing with the other existing wireless networks.

The super-frame control header 112 is now described in further detail. Firstly, super-frame control header 112 includes format information. For example, the system type such as IEEE 802.22 wireless networks or other systems types is included. Other common information can be included such as any desired symbol. The super-frames are time-coordinated between the overlapping wireless systems and the super-frame control headers of the same type of system will carry the same data, and so there will be no collision between this data and no data will be lost. Super-frame control header 112 also includes a header check sequence to check for lost data. Super-frame control header 112 contains common (the same) system information across all wireless systems on the same channel. Simultaneous transmissions of super-frame control headers containing different header contents will result in collisions. However, the use of the common control header information according to the present invention prevents such collisions. The control header information is transmitted simultaneously by all wireless networks on the same channel, which enables efficient wireless network detection and discovery by other wireless systems.

A co-existence beaconing protocol data unit is now described for use in the reserved self-coexistence windows. The purpose of the protocol data unit is for better coordination between the competing wireless systems so that the details of spectrum sharing can be negotiated, such as spectrum contention tokens and the exact pattern of spectrum sharing in time.

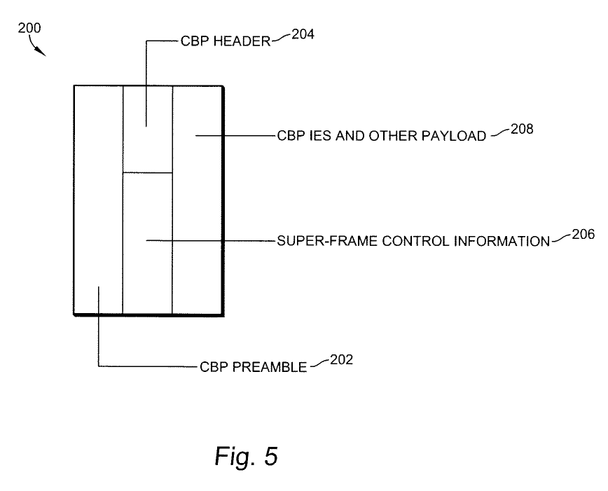

Referring now to FIG. 5, a three-symbol Coexistence Beaconing Protocol, Protocol Data Unit (“CBP PDU”) 200 is shown. CBP PDU 200 includes a CBP preamble 202, which contains a symbol. Immediately following the CBP preamble is a CBP header 204, which contains control information with regard to the usage of the CBP payload. Also following the CBP preamble is the super-frame control information (SCI) 206, that is described in further detail below. Finally, the CBP PDU 200 includes a CBP information element and other payload information, which is a collection of information components, such as spectrum sharing information or system usage information. The SCI format in the CBP PDU includes the system type, such as IEEE 802.22 wireless networks, or other system type if used. A wireless network ID is the system identification. The SCI format 206 also includes a data frame reservation map in the current super-frame, to establish a pattern of what system will be transmitting data during predetermined data frames within the super-frame. The data frame reservation map includes data frame allocation for data services, but also includes data frame allocation for quiet periods so that the operation of the licensed systems within the coverage area can be sensed and detected. Finally, the SCI format 206 also includes a self-coexistence window (SCW) reservation map, which establishes the pattern for reserving these windows amongst the competing wireless systems.

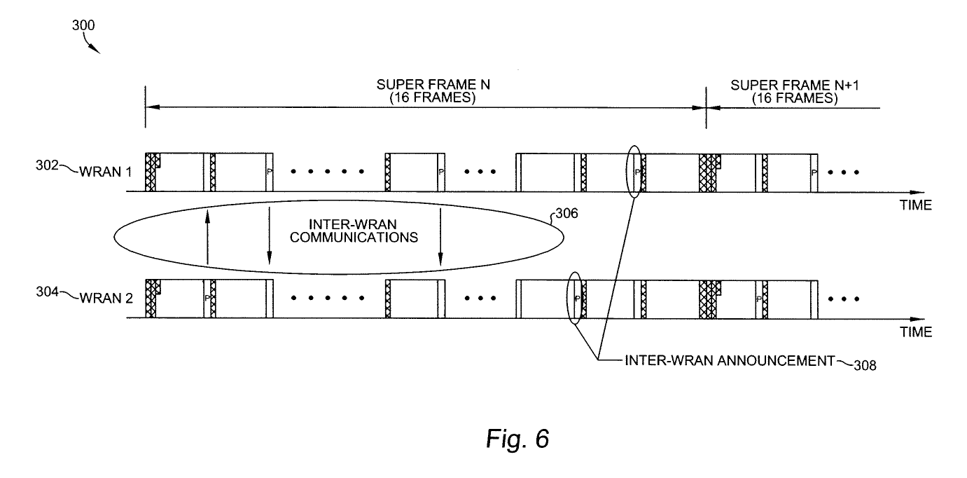

Referring now to FIG. 6, a wireless environment 300 including a first wireless network 302 and a second wireless network 304 is shown. FIG. 3 is a time-based representation of the negotiation between wireless networks (inter-wireless network communication 306) and the announcement of the results of the negotiations to other wireless systems and licensed systems as to the results of those negotiations (intra-wireless network announcement 308). Wireless networks 302 and 304 use SCWs (reserved or random-access based) to exchange coexistence messages. Negotiation for frame allocation and SCW allocation for the next (future) superframes are carried out during inter-wireless network communication 306. Note that in FIG. 3, communications during the reserved self-coexistence windows is shown that is taking place during several frames of the super-frame. Each wireless network base station uses its last reserved SCW to announce the latest negotiation decisions of bandwidth (frame and SCW) allocations to customer premises equipment (CPEs) within the wireless network cell. Note in FIG. 3 that the last reserved SCW during intra-wireless network announcement 308 is used for this purpose.

The “J” SCW, which is the last SCW in every super-frame, is accessed through CSMA (carrier sensing multiple access) by all wireless networks on a particular RF channel. CSMA is a contention-based method. Used complementarily with the reserved SCWs, the purposes of the “J” SCW is to allow, for example, a newly operating wireless network to communicate with the existing wireless networks or with the other newly starting wireless networks for spectrum resource reservation or contention (i.e. data frames or SCWs reservations), group joining, or other inter-wireless network communications purposes. A wireless network that doesn't have any SCW reservation to communicate with the other wireless networks.

Finally, coexistence communications (cross-channel) is explained according to the present invention.
Step 1: The wireless system on Channel “A” discovers the SCW reservation pattern on an in-band or out-of-band RF channel (Channel “X”). This can be done using the SCI information previously described or through constant monitoring of the channel.
Step 2: The wireless system on Channel “A” identifies the reserved SCWs (i.e. the Transmit Opportunities, “TXOPs”) of the source wireless networks (the ones to which the receiving wireless network intends to listen) on Channel “X” from the discovered SCW pattern.
Step 3: The wireless system on Channel “A” receives the CBP PDU packets during the reserved SCWs of the source wireless networks on Channel “X”, or during the J-SCW of Channel “X” in which the source wireless network could also transmit CBP packets.

The above three steps illustrate a one-way communication wherein the system on channel “A” desires to communicate with the wireless system on channel “X”. For two-way communication, the process is reversed, but the same. The wireless system on channel “A” becomes the wireless system on channel “X”, and vice versa.

According to the present invention, portions of the super-frame are transmitted by the base station, and portions of the super-frame are transmitted by CPEs.

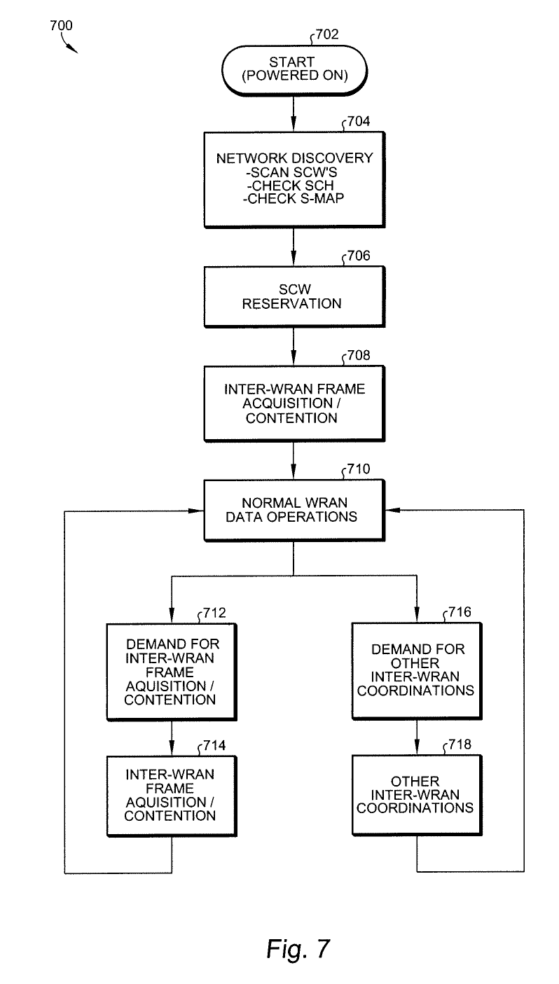

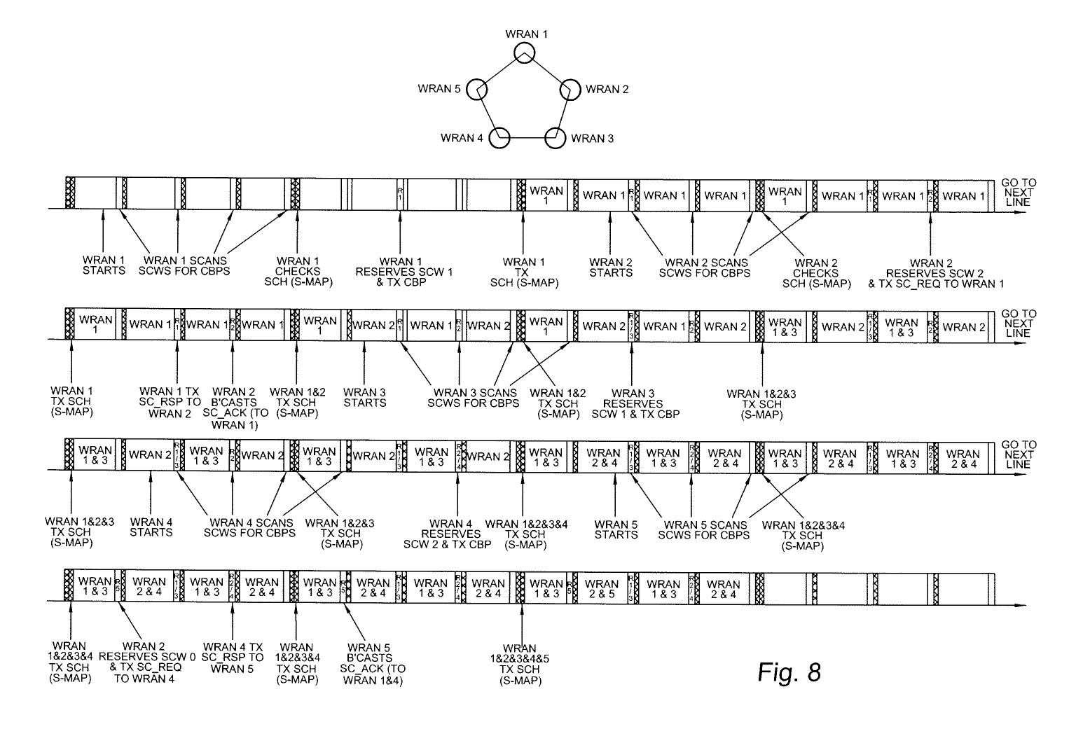

Referring now to FIGS. 7 and 8, the frame-based on-demand spectrum contention protocol-messaging method of the present invention is described in further detail.

In FIG. 7, a flow chart 700 is shown that sets forth the overall procedure according to the present invention. At step 702 the wireless system is powered on. At step 704, network discovery is performed. That is, a first wireless system desiring to enter into an existing second wireless system scans the self-coexistence windows of the super-frame structure of the existing second wireless system, checks the super-frame control header of the existing second wireless system, and checks the super-frame allocation map of the existing second wireless system. At step 706, the first wireless system makes a self-coexistence window reservation in the super-frame structure. To join the existing wireless system, the first wireless system enters into an inter-wireless network frame acquisition/contention phase at step 708 as is described above. Once the contention process is completed, normal wireless network data operations can begin at step 710. For continuing operations, further demands for spectrum sharing within the existing wireless network, or from external requests, results in further frame acquisition and contention at step 712. At step 714, new frames are acquired or contended for and normal operations resume at step 710. Simultaneously with steps 712 and 714, steps 716 and 718 are concerned with demands for spectrum sharing and wireless network coordination with licensed network systems that must operate within the context of the super-frame structure of the wireless network. For example, licensed network systems must operate during quiet frames when participating base stations are not broadcasting information.

A practical example of the protocol-messaging method of the present invention is shown in FIG. 8. In FIG. 8, five wireless systems are shown. Each wireless network is composed of a base station and a number of associated CPEs.

Each system is “one-hop” from the neighboring system in a pentagon shape. Such a configuration would be possible if, for example, there were a mountain in the middle of the pentagon shown in FIG. 8. In such a case, communications between only the second and fourth wireless networks, for example, would not be possible. Communication is only possible along the solid lines of the pentagon as shown in FIG. 8. In FIG. 8, four lines each containing four super-frames is shown. Please refer back to FIG. 4 for more detail on each of the super-frames. In FIG. 8, the superframes only contain four total frames, a first frame, two intermediate frames, and a last frame. The structure is the same otherwise, as in FIG. 4. The first frame can be identified by a three-symbol preamble. The next three frames each have a single symbol preamble and a self-coexistence window. The diagram of FIG. 8 shows the manner in which the protocol-messaging would take place amongst the five wireless systems.

Referring now to FIG. 8, line one, note that the first wireless system starts during the first frame of the first super-frame. The first wireless system then scans the self-coexistence windows of the first three frames for the coexistence beaconing protocol. The first wireless system then checks the super-frame control header for the super-frame allocation map. Once the super-frame allocation map has been checked, the first wireless system reserves a self-coexistence window and transmits a coexistence beaconing protocol. Subsequently, the first wireless system transmits a super-frame control header including a super-frame map and begins broadcasting data in all frames of the next super-frame. Note in FIG. 8 that each data portion of the frames is labeled “WRAN 1” corresponding to the first wireless system. In the second frame of the third super-frame of line one, the second wireless system starts up. The second wireless system scans the next four self-coexistence windows for the coexistence beaconing protocols, and, in the preamble of the fourth super-frame of the first line, checks super-frame allocation map. During the third self-coexistence window of the fourth super-frame of the first line, the second wireless system reserves an open self-coexistence window as shown, and transmits a spectrum contention request signal to the first wireless system. This completes the time sequence for line one shown in FIG. 8.

Referring now to FIG. 8, line two, the first wireless system transmits the super-frame control header including the allocation map. During the second self-coexistence window reserved by the first wireless system, the first wireless system transmits a spectrum contention response to the second wireless system. During the next self-coexistence window reserved by the second wireless system, the second wireless system broadcasts a spectrum contention acknowledgement signal to the first wireless system. During the preamble of the first frame of the second super-frame of the second line, the first and second wireless systems transmit the allocation map. Note that the first and second wireless systems now share spectrum as shown, wherein the data portions are alternated, with the first wireless system broadcasting during the first and third frames, and the second wireless system broadcasting during the second and fourth frames. During the second frame of the second super-frame of the third wireless system starts up, and begins scanning the SCWs for the CBPs. During the preamble of the third super-frame, the first and second wireless systems again transmit the super-frame allocation map. The third wireless system reserves a SCW occupied by the first wireless system. This is allowed since the first wireless system is two-hops from the third wireless system and thus the SCW can be shared. The first three wireless systems all transmit the new allocation map during the preamble of the fourth super-frame as shown. Note that the first three wireless systems are all sharing spectrum during the fourth super-frame. The first and third wireless systems broadcast data during frames one and three, and the second wireless system broadcasts data during frames two and four. This completes the time sequence for line two shown in FIG. 8.

Referring now to FIG. 8, line three, the first three wireless systems transmit the super-frame allocation map, which is unchanged from the end of line two. In the second frame the fourth wireless systems starts up and scans the SCWs for the CBPs. During the preamble of the second super-frame, the first three wireless systems again transmits the unchanged super-frame allocation map. However, during the third SCW, the fourth wireless system reserves an SCW, which is shared with the second wireless system. Since the second and fourth wireless systems are not “one-hop” this is permissible. At the beginning of the third super-frame, all four wireless systems transmit the new allocation map. Note that spectrum is now shared between all four wireless systems. Data in the first and third frames is shared between the first three wireless systems, and data in the second and fourth frames is shared between the second and fourth wireless systems. During the second frame of the third super-frame the fifth wireless system starts up and begins scanning the SCWs for the CBPs. At the preamble of the fourth super-frame, the allocation map for the four wireless systems is transmitted. This completes the time sequence for line three shown in FIG. 8.

Referring now to FIG. 8, line four, the first four wireless systems again transmit the allocation map. The fifth wireless system reserves the first self-coexistence window and transmits a spectrum contention request to the fourth wireless system. Subsequently, the fourth wireless system transmits a spectrum contention response to the fifth wireless system. In the third self-coexistence window the fourth wireless system transmits a spectrum contention response to the fifth wireless system. During the preamble of the second super-frame the first four wireless systems continue to transmit the allocation map. At the first self-coexistence window of the second super-frame, the fifth wireless system broadcasts a spectrum contention acknowledgement signal to the first and fourth wireless systems. During the preamble of the third super-frame the new allocation map is transmitted by all five wireless systems, and spectrum is shared by all five wireless systems. During the first and third frames of the third super-frame, the first and third wireless systems transmit data. During the second frame, the second and fifth wireless systems transmit data. During the fourth frame, the second and fourth wireless systems transmit data. This completes the time sequence for line four shown in FIG. 8.

Thus, FIG. 8 is an example of one scenario of how the frame-based on-demand spectrum contention protocol-messaging method of the present invention could occur in a practical example. While the five wireless system scenario is effective for demonstrating the frame-based approach of the method of the present invention, it is clear to those skilled in the art that any number of wireless systems in any configuration could be used.

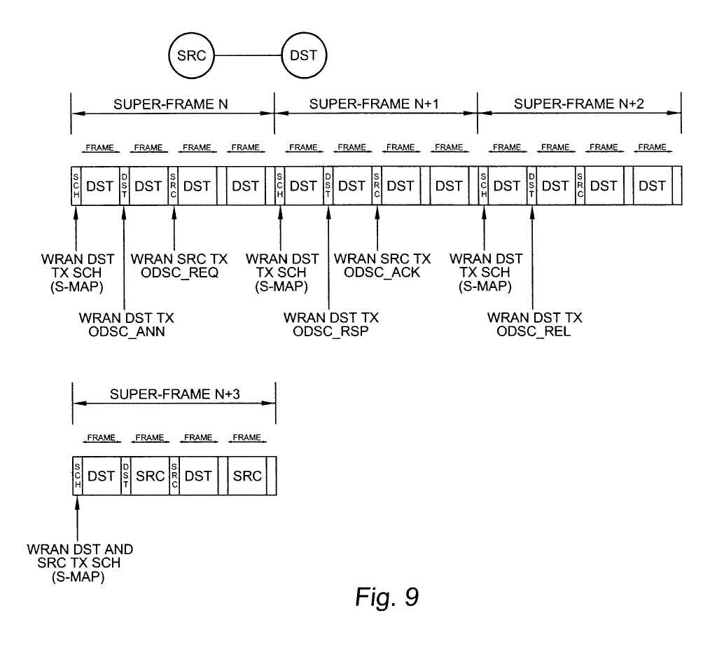

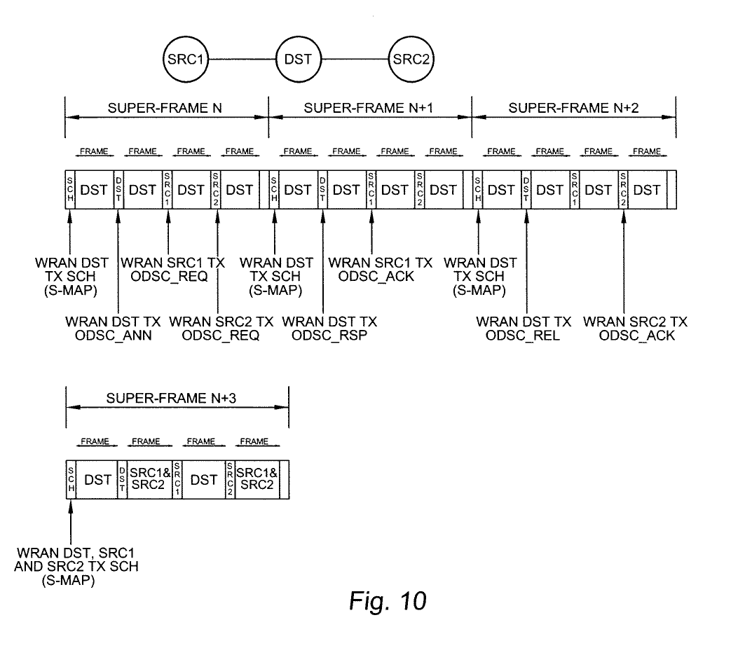

The super-frame protocol-messaging method of the present invention shown in FIG. 8 can be applied, for example, to the basic ODSC message flows diagrams shown in FIG. 1(a), which corresponds to FIG. 9, and FIG. 1(b), which corresponds to FIG. 10.

In FIG. 9, two wireless systems are shown, a source WRAN and a destination WRAN. Each wireless network is composed of a base station and a number of associated CPEs. The superframe structure used for the messaging flow in FIG. 9 is the same as described above. The diagram of FIG. 9 shows the manner in which the protocol-messaging would take place amongst the two wireless systems, assuming the destination WRAN and the source WRAN reserve the first and the second self-coexistence windows respectively in each super-frame.

Referring to the first super-frame N in FIG. 9, the destination WRAN transmits a super-frame allocation map during the super-frame control header. All data frames are taken up with data from the destination WRAN in the first super-frame N. During the first self-coexistence window the destination WRAN transmits the ODSC_ANN announcement. During the second self-coexistence window the source WRAN transmits the ODSC_REQ request.

Referring to the second super-frame N+1 in FIG. 9, the destination WRAN again transmits the super-frame allocation map during the super-frame control header. All data frames are again taken up with data from the destination WRAN in the second super-frame N+1. During the first self-coexistence window the destination WRAN transmits the ODSC_RSP response. During the second self-coexistence window the source WRAN transmits the ODSC_ACK acknowledgment.

Referring to the third super-frame N+2 in FIG. 9, the destination WRAN again transmits the super-frame allocation map during the super-frame control header. All data frames are still taken up with data from the destination WRAN in the third super-frame N+2. During the first self-coexistence window the destination WRAN transmits the ODSC REL release command. The second self-coexistence window is occupied by the source WRAN, but the messaging flow protocol is concluded by the release command.

Referring to the fourth super-frame N+3 in FIG. 9, note that both the source and the destination WRANs are transmitting super-frame allocation maps during the super-frame control header. Note also that the data frames are now shared between the destination WRAN and the source WRAN according to the frame contention results. The first and third data frames are occupied by the destination WRAN and the second and fourth data frames are occupied by the source WRAN. The first self-coexistence window is occupied by the destination WRAN and the second self-coexistence window is occupied by the source WRAN although no commands for the message flow are transmitted during super-frame N+3.

In FIG. 10, three wireless systems are shown, two source WRANs and a destination WRAN. Each wireless network is composed of a base station and a number of associated CPEs. The superframe structure used for the messaging flow in FIG. 9 is the same as is described above. The diagram of FIG. 10 shows the manner in which the protocol-messaging would take place amongst the three wireless systems, assuming the destination WRAN and the two source WRANs reserve the first, the second and the third self-coexistence windows respectively in each super-frame.

Referring to the first super-frame N in FIG. 10, the destination WRAN transmits a super-frame allocation map during the super-frame control header. All data frames are taken up with data from the destination WRAN in the first super-frame N. During the first self-coexistence window the destination WRAN transmits the ODSC_ANN announcement. During the second self-coexistence window the first source WRAN transmits an ODSC_REQ request. During the third self-coexistence window the second source WRAN also transmits an ODSC_REQ request.

Referring to the second super-frame N+1 in FIG. 10, the destination WRAN again transmits the super-frame allocation map during the super-frame control header. All data frames are again taken up with data from the destination WRAN in the second super-frame N+1. During the first self-coexistence window the destination WRAN transmits the ODSC_RSP response. During the second self-coexistence window the first source WRAN transmits an ODSC_ACK acknowledgment. The third self-coexistence window is occupied by the second source WRAN although no commands are given during the second super-frame N+1.

Referring to the third super-frame N+2 in FIG. 10, the destination WRAN again transmits the super-frame allocation map during the super-frame control header. All data frames are still taken up with data from the destination WRAN in the third super-frame N+2. During the first self-coexistence window the destination WRAN transmits the ODSC_REL release command. The second self-coexistence window is occupied by the first source WRAN, but no messaging flow command is transmitted. During the third self-coexistence window the second source WRAN transmits an ODSC_ACK acknowledgment.

Referring to the fourth super-frame N+3 in FIG. 10, note that all three WRANs are transmitting super-frame allocation maps during the super-frame control header. Note also that the data frames are now shared between all three WRANs according to the frame contention results. The first and third data frames are occupied by the destination WRAN and the second and fourth data frames are occupied by the first and second source WRANs. The first self-coexistence window is occupied by the destination WRAN, the second self-coexistence window is occupied by the first source WRAN, and the third self-coexistence window is occupied by the second source WRAN. No commands for the message flow are transmitted during the fourth super-frame N+3.

Although an embodiment of the present invention has been described for purposes of illustration, it should be understood that various changes, modification and substitutions may be incorporated in the embodiment and method of the present invention without departing from the spirit of the invention that is defined in the claims, which follow.

We claim:

1. A frame-based on-demand spectrum contention protocol-message method comprising:
providing a super-frame structure for use in a wireless system;
scanning a plurality of self-coexistence windows for coexistence beaconing protocols by the wireless system; and
checking a super-frame allocation map by the wireless system.

2. The method of claim 1 further comprising checking a super-frame allocation map by the wireless system during a first frame of the super-frame structure.

3. The method of claim 1 further comprising reserving a self-coexistence window by the wireless system.

4. The method of claim 1 further comprising transmitting a coexistence beaconing protocol by the wireless system

5. The method of claim 1 further comprising transmitting a super-frame allocation map by the wireless system.

6. The method of claim 1 further comprising contention between a plurality of wireless systems during transmission of a plurality of self-coexistence windows.

7. The method of claim 6 further comprising transmitting an updated super-frame allocation map by all of the wireless systems.

8. The method of claim 6 further comprising a super-frame structure including data frames from all coexisting wireless systems.

9. The method of claim 6 further comprising a super-frame structure including self-coexistence windows reserved by all of the wireless systems.

10. The method of claim 6 wherein at least two wireless systems have overlapping coverage areas.

11. The method of claim 1, wherein the super-frame structure comprises a plurality of frames, wherein a first frame includes a super-frame preamble, a super-frame control header, a data portion, and a regular self-coexistence window.

12. The method of claim 11 wherein the super-frame preamble comprises a first OFDM symbol and a second OFDM symbol.

13. The method of claim 11 wherein the super-frame control header is compatible with the IEEE 802.22 standard.

14. The method of claim 11 wherein the super-frame control header comprises information common to other wireless networks.

15. The method of claim 11 wherein the super-frame control header comprises a header check sequence.

16. The method of claim 11 wherein the regular self-coexistence window comprises a reserved self-coexistence window.

17. The method of claim 11 wherein the regular self-coexistence window comprises the coexistence beaconing protocol.

18. The method of claim 17 wherein the coexistence beaconing protocol comprises a three-symbol protocol data unit.

19. A frame-based on-demand spectrum contention protocol-messaging method comprising: powering a wireless system;
performing network discovery wherein a first wireless system desiring to enter into an existing second wireless system scans the self-coexistence windows of the super-frame structure of an existing second wireless system, checks the super-frame control header of the existing second wireless system, and checks the super-frame allocation map of the existing second wireless system;
making a self-coexistence window reservation in the super-frame structure by the first wireless system;
entering into an inter-wireless network frame acquisition/contention phase by the first wireless system; and
once the contention process is completed, beginning normal wireless network data operations.

20. The method of claim 19 wherein further demands for spectrum sharing within the existing wireless network, or from external requests, results in a further frame acquisition and contention.

21. A super-frame-based on-demand spectrum contention protocol-messaging method comprising:
providing a source wireless network and a destination wireless network;
during a first plurality of self-coexistence windows the destination wireless network transmits an announcement, a response, and a release; and
during a second plurality of self coexistence windows the source wireless network transmits a request and an acknowledgment.

22. The method of claim 21 wherein the first plurality of self-coexistence windows comprises first, third, and fifth self-coexistence windows, and the second plurality of self-coexistence windows comprises second and fourth self-coexistence windows.

23. The method of claim 22 wherein the first and second self-coexistence windows occur in a first super-frame.

24. The method of claim 23 wherein the third and fourth self-coexistence windows occur in a second super-frame.

25. The method of claim 25 wherein the fifth self-coexistence window occurs in a third super-frame.

26. The method of claim 21 wherein the destination wireless network transmits a super-frame allocation map during a super-frame control header of a first, second, and third super-frame.

27. The method of claim 26 wherein both the source and the destination wireless networks transmit super-frame allocation maps during a super-frame control header of a fourth super-frame.

28. The method of claim 21 wherein data frames of a first, second, and third super-frame are occupied by data from the destination wireless network.

29. The method of claim 28 wherein data frames of a fourth super-frame are shared between the destination wireless network and the source wireless network.

30. A super-frame-based on-demand spectrum contention protocol-messaging method comprising:
providing a first source wireless network, a second source wireless network, and a destination wireless network;
during a first plurality of self-coexistence windows the destination wireless network transmits an announcement, a response, and a release;
during a second plurality of self-coexistence windows the first source wireless network transmits a request and an acknowledgment; and
during a third plurality of self-coexistence windows the second source wireless network transmits a request and an acknowledgment.

31. The method of claim 30 wherein the first plurality of self-coexistence windows comprises first, fourth, and sixth self-coexistence windows, the second plurality of self-coexistence windows comprises second and fifth self-coexistence windows, and the third plurality of self-coexistence windows comprises third and seventh self-coexistence windows.

32. The method of claim 31 wherein the first, second and third self-coexistence windows occur in a first super-frame.

33. The method of claim 32 wherein the fourth and fifth self-coexistence windows occur in a second super-frame.

34. The method of claim 33 wherein the sixth and seventh self-coexistence windows occur in a third super-frame.

35. The method of claim 30 wherein the destination wireless network transmits a super-frame allocation map during a super-frame control header of a first, second, and third super-frame.

36. The method of claim 35 wherein both source wireless networks and the destination wireless networks transmit super-frame allocation maps during a super-frame control header of a fourth super-frame.

37. The method of claim 30 wherein data frames of a first, second, and third super-frame are occupied by data from the destination wireless network.

38. The method of claim 37 wherein data frames of a fourth super-frame are shared between the destination wireless network and the source wireless networks.
